(19) United States
(12) Patent Application Publication
(10) Pub. No.: US 2005/0123695 A1
(43) Pub. Date: Jun. 9, 2005

(54) Ink-jet recording material and ink-jet recording method

(75) Inventors: Takayuki Suzuki, Tokyo (JP); Kiyoshi Endo, Kaisei-machi (JP); Tomohiko Sakai, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Holdings, Inc.

(21) Appl. No.: 10/999,688

(22) Filed: Nov. 30, 2004

(30) Foreign Application Priority Data
Dec. 8, 2003 (JP) JP2003-408645

(51) Int. Cl. B41M 5/00

(52) U.S. Cl. 428/32.3

(57) ABSTRACT

An ink-jet recording material comprising a substrate having thereon an ink absorbing layer containing a mordant which exhibits the following properties: when a thin layer chromatograph is prepared by immersion coating in 1 weight % aqueous solution of the mordant, the thin layer chromatography results in; a) an Rf flow rate value being equal at most 0.4, when a dye represented by following Formula (1) is developed using a developing solvent containing ethanol and water at a volume ratio of 1:1; b) the Rf value being at most 0.3, when C. I. Direct Blue 199 dye is developed using the same developing solvent; and c) the Rf value being at most 0.5, when C. I. Direct Yellow 86 dye is developed using the same developing solvent.

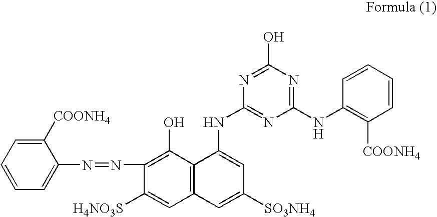

### FIELD OF THE INVENTION

The present invention relates to an ink-jet recording material and an ink-jet recording method using the same.

### BACKGROUND OF THE INVENTION

In ink-jet recording, minute ink droplets are ejected by various principles and adhered onto a recording material, such as paper, to record an image or text. This method has many advantages such as that the images can be formed at a relatively high rate at low noise, and multiple color images can be as easily printed.

Heretofore, clogging and maintenance of the nozzles has been a major problem for the ink-jet method. However, these problems are negligible from both of the aspects of the ink and the apparatus, and the method is rapidly spreading in various fields such as for use in printers, facsimile machines and computer terminals.

The recording material employed for this ink-jet recording method requires that printed dot density is high enough, color is bright and clear, ink absorption rate is high to result in no bleeding even when dots are overlapped, and diffusion of printed dots in the lateral direction is reasonably small, resulting in a smooth edge with no blurring.

To achieve these requirements, many methods have been proposed. For example, of the many known ones are: a recording sheet which is coated with a medium as a surface treatment on a low sizing paper, described in Unexamined Japanese Patent Application Publication (hereinafter, referred to as JP-A) 52-53012; a recording sheet which is provided with an ink absorptive layer on the surface of a substrate, described in JP-A 55-5830; a recording sheet which contains non-colloidal silica particles as a pigment in a covering layer, described in JP-A 56-157; a recording paper which contains both an inorganic pigment and an organic pigment, described in JP-A 57-107878; a recording sheet which has two peaks in a void distribution, described in JP-A 58-110287; a recording sheet which has two porous layers, described in JP-A 62-111-782; recording sheets having infinite form cracks, described in JP-A Nos. 59-68292, 59-123696 and 60-18383; recording sheets which have a layer containing micro-particles, described in JP-A Nos. 61-135786, 61-148092 and 62-149475; recording sheets which contain a pigment or micro-particle silica having certain physical property values, described in JP-A Nos. 63-252779, 1-108083, 2-136279, 3-65376 and 3-27976; recording sheets containing micro-particle silica such as colloidal silica, described in JP-A Nos. 57-14091, 60-219083, 60-210984, 61-20797, 61-188183, 5-278324, 6-92011, 6-183134, 7-137431 and 7-276789; and recording sheets containing alumina hydrate micro-particles, described in JP-A Nos. 2-276671, 3-67684, 3-215082, 3-251488, 4-67986, 4-263983 and 5-16517.

The various foregoing ink-jet recording sheets have drawbacks such as bleeding or spreading of dyes, when water droplets touch the recording surface or a recorded sheet is stored under high humidity over a long period after printing, because dye molecules present in a binder or among voids by themselves, differ from photographic color print paper in which dye molecules are dispersed in an oil solution in a state of high density and as micro-particles.

To improve water resistance and humidity resistance of dyes, generally employed are incorporated mordants, which is a substance employed to fix dyes in an ink absorption layer. As examples of substances capable of fixing dyes, listed are an inorganic pigment the surface of which is cationic, such as alumina micro-particles; and a cationic polymer which has a primary or tertiary amino group or a quaternary ammonium salt group in its molecules. Of these, the foregoing polymer is preferably employed, due to its relatively high dye fixing capability.

For example, in JP-A 53-49113, described is a recording sheet for a water based ink, in which paper polyethylene imine is impregnated. In JP-A 58-24492, described is a recording material containing an electrolyte polymer having a cationic or an anionic group. In JP-A 63-224988, described is a recording material containing a primary or tertiary amine or a quaternary ammonium salt in an ink receiving layer, in which the pH of the ink receiving layer is in the range of 2-8. In JP-A 63-307979, described is an ink-jet recording sheet having a layer containing a hydrophilic polymer mordant having a tertiary or quaternary nitrogen atom as well as a polymer having a hydrophilic group. In JP-A Nos. 59-198186 and 59-198188, described are recording materials containing an organic salt group of polyethylene imine in a substrate or a layer coated onto a substrate. In JP-A 60-46288, described is an ink-jet recording method using an ink containing a specific dye and a recording material containing a polyamine. In JP-A Nos. 61-61887, 61-72581, 61-252189 and 62-174184, described are ink-jet recording sheets containing a polyacrylamine. In JP-A 61-172786, described is an ink-jet recording material containing a polymer having an intermolecular hydrogen bond, such as gelatin and polyethylene imine, and a polymer having no hydrogen bonding group among its molecules. In JP-A 63-162275, described is an ink-jet recording sheet on the substrate of which a cationic polymer and a cationic surface active agent are coated or impregnated. In JP-A 6-143798, described is a recording sheet, on which plastic substrate, a dye fixing layer containing a quaternary ammonium salt polymer and a cation modified polyvinyl alcohol as main components, are provided, and a dye transferable/ink absorbing layer is provided thereon. Further, in JP-A Nos. 59-20696, 59-33176, 59-33177, 59-96987, 59-155088, 60-11389, 60-49990, 60-83882, 60-109894, 61-277484, 61-293886, 62-19483, 62-198493, 63-49478, 63-115780, 63-203896, 63-274583, 63-280681, 63-260477, 1-9776, 1-24784, 1-40371, 3-133686, 6-234268 and 7-125411, described are addition of a polymer or compound having a certain tertiary or quaternary nitrogen atom into an ink receiving layer.

As a dye mordant exhibits higher dye fixing capability, the more water resistance and image bleeding, during storage after ink-jet recording, are improved, therefore, the most suitable dye mordant to the dye contained in the ink is selected (for example, please refer to Non-Patent Document 1).

However, in ink-jet recording sheets described in the foregoing patents, in cases when a dye mordant is added in a large amount to meet desired water resistance, ink absorbing rate is lowered and unevenness of images tends to occur, especially during recent higher rate ink-jet recording, resulting in practice in situations of not solving the foregoing problems, especially regarding image quality.

Non-Patent Document 1: Ink-jet Printer Gijutsu to Zairyo (Ink-jet Printer Technology and Materials), pp. 268-269, CMC Publishing Co., Ltd.

### SUMMARY OF THE INVENTION

The present invention was achieved in view of the above problems. An object of the present invention is to provide an ink-jet recording material which exhibits superior ink absorbability, high resolution, high image quality and coloration, when employed in an ink-jet printer, and an ink-jet recording method using the same.

These and other objects of the invention are accomplished by an ink-jet recording material containing a support having thereon an ink absorbing layer which contains a mordant exhibiting the following properties: when a thin layer chromatography is prepared by immersion using 1 weight % aqueous solution of the mordant, the thin layer chromatography results, Rf flow rate values of a dye represented by following Formula (1), C. I. Direct Blue 199 dye and C. I. Direct Yellow 86 dye being in a specific value range, when the dyes are developed using a developing solvent containing ethanol and water at a volume ratio of 1:1.

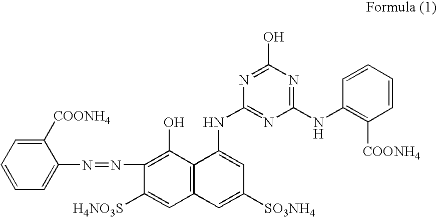

Based on the present embodiment, it is possible to provide an ink-jet recording material which exhibits superior ink absorbability, high resolution, high image quality and coloration, when employed in an ink-jet printer, and an ink-jet recording method using the same.

### DETAILED DESCRIPTION OF THE INVENTION

The details of the present invention will now be described.

The objects of the present invention were achieved employing the following embodiments.

Item 1. An ink-jet recording material comprising a substrate having thereon an ink absorbing layer containing a mordant which exhibits the following properties:
when a thin layer chromatography is prepared by immersion coating using 1 weight % aqueous solution of the mordant, the thin layer chromatography results in;
a) an Rf flow rate value of 0.4 or less, when a dye represented by the foregoing Formula (1) is developed using a developing solvent containing ethanol and water at a volume ratio of 1:1;
b) an Rf value of 0.3 or less, when C. I. Direct Blue 199 dye is developed using a developing solvent containing ethanol and water at a volume ratio of 1:1; and
c) an Rf value of 0.5 or less, when C. I. Direct Yellow 86 dye is developed using a developing solvent containing ethanol and water at a volume ratio of 1:1.

Item 2. The ink-jet recording material of Item 1 above, wherein the ink absorbing layer comprises pulverized silica micro-particles which are produced by a sedimentation or a gel method.

Item 3. The ink-jet recording material of Item 2 above, wherein the mordant comprises a cationic polymer containing polystyrene having a quaternary ammonium salt group.

Item 4. The ink-jet recording material of Item 3, wherein the mordant further comprises a cationic polymer having a polyacrylamine salt group.

Item 5. The ink-jet recording material of Item 3, wherein the mordant further comprises a cationic polymer having a polydiallyldimethyl ammonium salt group.

Item 6. The ink-jet recording material of Item 3, wherein the mordant further comprises a basic aluminum chloride.

Item 7. An ink-jet recording method comprising the step of ejecting droplets of the following set of inks from an ink-jet head onto the ink-jet recording material of Item 2, the set of inks containing:
a) a water based ink comprising the dye represented by the foregoing Formula (1),
b) a water based ink comprising C. I. Direct Blue 199 dye, and
c) a water based ink comprising C. I. Direct Yellow 86 dye.

The ink-jet recording material of the present invention (hereinafter, also referred to the recording material of this invention) has an ink absorbing layer applied onto a substrate.

As a substrate for the recording material of this invention, any water absorbing or a non-water absorbing substrate may be employed. However, a non-water absorbing substrate is preferably employed, due to absence of wrinkling after printing, uniform smoothness for a high quality print, and ease of forming a glossy surface. Further, as a water absorbing substrate, specifically typical is a paper substrate containing natural pulp as a main component, but a mixture of synthetic and natural pulp is acceptable. As non-water absorbing substrates, listed are a plastic resin film substrate, and a paper substrate covered on both sides with a plastic resin. Examples of plastic resin film substrates are polyester film, polyvinyl chloride film, polypropylene film, cellulose triacetate film, polystyrene film and laminations of these films. These plastic films may be transparent or translucent. A specifically preferable substrate of this invention is a paper one covered on both sides with a plastic resin, but most preferable is one covered on both sides with a polyolefin resin. The specifically preferable paper substrate covered on both sides with a polyolefin resin will be described below.

Base paper employed for the paper support of the present invention is made employing wood pulp as a main raw material and if desired, synthetic pulp such as polypropylene or synthetic fiber such as nylon or polyester mixed with the foregoing wood pulp may be employed. Employed as the wood pulp may, for example, be: LBKP, LBSP, NBKP, NBSP, LDP, NDP, LUKP, or NUKP [incidentally: L=pulp from broad leaf trees, N=pulp from coniferous trees, BK=sulfate bleached (pulp), ND=sulfite bleached (pulp), and P=pulp], of which it is preferable to use LBKP, NBSP, LBSP, NDP, or LDP in large quantity, all of which contain a relatively large amount of short fibers. However, the ratio of LBSP and/or LDP is preferably 10-70% by weight.

Preferably employed as the foregoing pulp is chemical pulp such as sulfate pulp and sulfite pulp, with minimal impurities. Further, useful is pulp which has been subjected to a bleaching treatment to enhance whiteness. It is acceptable to incorporate into the base paper sizing agents such as higher fatty acids or alkyl ketene dimers, white pigments such as calcium carbonate, talc, or titanium oxide, paper strengthening agents such as starch, polyacrylamide, or polyvinyl alcohol, fluorescent brightening agents, moisture retention agents such as polyethylene glycol, dispersing agents, and softening agents such as quaternary ammonium.

The “freeness” of pulp used for paper making is preferably 200-500 ml under the specification of CSF, while regarding fiber length after beating, the sum of weight% of 24 mesh residue and weight% of 42 mesh residue, which are specified in JIS P 8207, is preferably 30-70%. Incidentally, weight percent of 4 mesh residue is preferably 20 weight percent or less. The basic weight of base paper is preferably 50-250 g, but is particularly preferably 70-200 g, while the thickness of the base paper is preferably 50-210 μm. Base paper may be treated for high smoothness employing calender finishing during or after paper making. The density of base paper is customarily 0.7-1.2 g/cm³ (based on the method specified in JIS P 8118). Further, the stiffness of base paper is preferably 20-200 g under conditions specified in JIS P 8143. Surface sizing agents may be applied onto the surface of the base paper. Employed as surface sizing agents may be the same ones as those which may be incorporated into the base paper. The pH of base paper, when determined by the hot water extraction method specified in JIS P 8113, is preferably 5-9.

Next, the polyolefin resin for covering both surfaces of the paper substrate is described below. Polyethylene (PE), polypropylene (PP), and polyisobutylene are usable for that purpose, but polyolefins such as copolymers principally composed of propylene are preferable while polyethylene is most preferred.

The most preferable polyethylene is described below. Polyethylene to be used for covering the front and rear surfaces of the paper substrate is mainly low density polyethylene (LDPE) and/or high density polyethylene (HDPE), but LLDPE (being a linear low density polyethylene) and polypropylene, other than the above, can be partially employed. The polyolefin layer, coated on the image receiving layer coated side, is one improved in opacity and whiteness by addition of rutile type of anatase type titanium oxide, which is preferred. The content of the titanium oxide is approximately 1-20%, but is preferably 2-15% of the polyolefin. Tinting pigments featuring high heat resistance as well as fluorescent whitening agents may be added to the polyolefin layer to control background whiteness.

Examples of the usable tinting pigments include: ultramarine blue, Prussian blue, cobalt blue, phthalocyanine blue, manganese blue, cerulean, tungsten blue, molybdenum blue and anthraquinone blue. Examples of the usable whitening agents include: dialkylaminocoumaline, bis-dimetylaminostilbene, bis-methylaminostilbene, 4-alkoxy-1,8-naphthalene dicarboxylic acid-N-alkylimide, bis-benzoxazolylethylene and dialkylstilbene.

The utilized amount of polyethylene providing on the front or rear surface of the raw paper base is chosen to optimize the thickness of the ink absorbing layer and to minimize curling at low humidity, as well as high humidity, after providing a backing layer. The thickness of the polyethylene layer on the ink absorbing layer side is usually 15-40 μm, and that of the polyethylene layer on the backing layer side is usually in the range of 10-30 μm. The ratio of polyethylene on the front and rear surfaces is optimally chosen to minimize curling, which may vary with the kind and thickness of the ink absorbing layer and the thickness of the raw paper base. Generally the thickness ratio of the front/rear surface is respectively 3/1-1/3. Further, the foregoing paper substrate covered with polyethylene preferably exhibits the following properties:
(1) Tensile strength in the longitudinal direction is preferably 2-30 kg and that in the lateral direction is 1-20 kg in terms of parameters specified in JIS-P-8113.
(2) Tear strength in the longitudinal direction is preferably 10-300 g and 20-400 g in the lateral direction in terms of parameters specified in JIS-P-8116.
(3) The compression elastic modulus is preferably more than 9.8×10⁷ Pa.
(4) Opacity is preferably more than 50%, but is specifically preferably 85-98%, when measured employing the method specified in JIS P 8138.
(5) Whiteness at L*, a*, b* are each preferably L*=80−95, a*=−3−+5, and b*=−6−+2, in terms of whiteness specified in JIS Z 8729.
(6) Clark stiffness: a preferable support exhibits a Clark stiffness of 20-400 cm³/100 in the transfer direction of the recording material.
(7) Moisture content of the raw paper base is preferably 4-10% to the core paper.

The ink-jet recording material of this invention preferably has an ink absorbing layer on the foregoing substrate.

Next, an ink absorbing layer will now be described.

In the ink absorbing layer of the recording material of this invention, a mordant exhibiting desired properties is incorporated to improve water resistance and humidity resistance after printing. The mordant of this invention is characterized by exhibiting the following properties. Further, one of the preferable embodiments is that more than two kinds of mordants may be in used combination. In cases when only one mordant cannot exhibit all the following desired properties, mixing two or more kinds of mordants may exhibit the following properties:
(1) Employing thin layer chromatography prepared by using 1 weight % aqueous solution of a mordant with immersion, the Rf flow rate value of the foregoing dye represented by foregoing Formula (1) (described in JP-A 2003-238850) is equal to 0.4 or less, when the dye is developed using a developing solvent containing ethanol and water at a volume ratio of 1:1. The value is however preferably not more than 0.2, but most preferably not more than 0.1.
(2) Employing thin layer chromatography prepared by using 1 weight % aqueous solution of a mordant with immersion, the Rf value of C. I. Direct Blue 199 dye is equal to 0.3 or less, when the dye is developed using a developing solvent containing ethanol and water at a volume ratio of 1:1. The value is however preferably not more than 0.2, but most preferably not more than 0.1.
(3) Employing thin layer chromatography prepared by using 1 weight % aqueous solution of a mordant with immersion, the Rf value of C. I. Direct Yellow 86 dye is equal to 0.5 or less, when the dye is developed using a developing solvent containing ethanol and water at a volume ratio of 1:1. The value is however preferably not more than 0.3, but most preferably not more than 0.2.

Any of the Rf values may be zero.

In this invention, the Rf flow rate value is determined based on the following method. That is, firstly 1 weight % aqueous solution of a mordant is prepared. Then a commercially available TLC aluminum plate of Silica Gel 60F254 (produced by Merck & Co., Inc., size: 20×20 cm, thickness of the a silica gel layer: 200 μm) is cut to a piece of 1×10 cm, after which the piece is appropriately soaked in the aqueous solution of the mordant, to prepare thin layer chromatography by immersion coating with the mordant. Next, onto this thin layer chromatography plate, about 0.1 μl of 1 weight % aqueous solution of the dye [being the dye represented by foregoing Formula (1), C. I. Direct Blue 199 or C. I. Direct Yellow 86] is dripped. After drying, one end of the plate is immersed into a vessel containing a developing solvent containing methanol and water at a volume ratio of 1:1, and the vessel is tightly sealed for development. The Rf flow rate value is then determined, which is the traveled distance ratio of the dye and the developing solvent, when the developing solution rises to a specific height. In cases when a traveled dye has a range, the largest value is employed as the Rf value. When the Rf value is large, the absorptive capability of the dye and the foregoing mordant is weak, and conversely when the Rf value is small, the absorptive capability is strong.

Examples of the foregoing mordants include an inorganic pigment having a cationic surface such as aluminum micro-particles, a water soluble metallic compound, an inorganic ionic polymer such as basic aluminum chloride, and a cationic polymer having a primary or tertiary amino group or-a quaternary ammonium salt group in the molecule. Specific examples of mordants are described in Ink-jet Printer Technology and Materials, pp. 268-269, published by CMC publishing Co., Ltd.

Mordants are incorporated in an ink absorbing layer, and are generally employed in an amount of 0.01-10 g per m² of the ink-jet recording material, and preferably in the range of 0.5-3 g. Since the mordant incorporated in the recording material of this invention exhibits the foregoing properties, it has a profound effect even at small amounts and can prevent a decrease of ink absorbing rate. Therefore, when ink-jet recording is conducted at a high production rate, images can be obtained which exhibit image surface uniformly, high resolution, high image quality and excellent image coloration.

The recording material of this invention has at least one of an ink absorbing layer, but may have more than two ink absorbing layers having different physical properties or constituent materials. For example, an ink absorbing layer of a multi-layer structure may be employed, in which the upper layer is an ink absorbing layer controlled to have the desired absorption coefficient for the ink, and the lower layer is an ink absorbing layer controlled to have a larger ink absorbing volume. Further, an ink absorbing layer may be provided on only one side of a substrate, or the both sides. In this case, ink absorbing layers provided on both sides may be the same or different. Ink absorbing layers are divided broadly into a swelling type ink absorbing layer and a porous type, of which either one may be employed. Further, a swelling type ink absorbing layer and a porous type may be used in combination. For example, a layer structure to provide a swelling type ink absorbing layer on the near side of a substrate and a porous type one on the far side, may be employed, and a reverse layer structure may also be employed. Further, in cases when ink absorbing layers are provided on both sides of a substrate, the ink absorbing layers may be the same or different types for the front and rear surfaces. In this invention, specifically preferred is a porous type ink absorbing layer, which preferably has a void type layer of a porous film containing inorganic or organic micro-particles and a small amount of a hydrophilic polymer. In this invention, it is preferred to employ in the ink absorbing layer, pulverized micro-particle silica, produced by a sedimentation method or a gel method.

The silica production by a sedimentation method of this invention is widely known. Firstly sodium silicate and sulfuric acid are mixed. By controlling the mixing parameters, such as temperature, silica contents, and time, silica can be deposited in the solution. Deposited silica is precipitated and after aging, filtration, washing, drying, grinding and classifying are conducted to produce synthetic amorphous silica.

Further, silica produced by a gel method of this invention is also widely known. Firstly, sodium silicate and sulfuric acid are promptly mixed to change from hydrosol to hydrogel. After washing the morphed hydrogel, the surface area is adjusted via a heat treatment, after which the hydrogel is dried and classified to obtain synthetic amorphous silica.

Silica produced by a sedimentation method or a gel method, preferably employed in this invention, is characterized by being used as pulverized micro-particle silica. The term pulverized means that silica aggregates of 1.0-50 μm are powdered in a dispersion medium by a mechanical means. The average particle diameter before pulverization is preferably 1.0-10 μm. Examples of this silica is on the market as Fine Seal and Toku Seal, produced by Tokuyama Corp., and Nipgel and Nipsil, produced by Nippon Silica Industrial Co., Ltd.

The pulverization method preferably has a preliminary dispersion process and a main dispersion process, and the usable pulverization methods include: a high-speed stirring disperser, an ultra-sonic disperser, and a wet-media type pulverizer (such as a sand mill and a ball mill). The silica content at pulverization is preferably 20-50 weight % from the view point of production efficiency and handling, but more preferably 25-40 weight %. The pulverized micro-particle silica may be passed through a coarse particle controlling process, using methods such as a centrifugal method and a filtration method. As a centrifugal method, for example, employed is Micro Cut, manufactured by Krettek Verfahrenstechnik GmbH. Employable filters include Profile, produced by Nihon Poll Ltd. and TCPD, produced by Advantec Toyo Kaisha, Ltd.

The foregoing dispersion medium is not specifically limited, but an aqueous medium is preferred, and the aqueous medium preferably contains a cationic polymer and a hardening agent, in addition to water. As examples of cationic polymers, listed are those described in JP-A 2002-47454.

As to the foregoing hardening agent, generally preferred are compounds which contain a reactive group with the foregoing hydrophilic polymer or which accelerate the reaction of different groups with each other contained in the hydrophilic polymer, while the employed hardening agent is appropriately selected based on the kinds of hydrophilic polymers. Specific examples of hardening agents include epoxy type hardening agents, such as diglycidylethyl ether, ethylene glycol diglycidyl ether, 1,4-butanediolediglycidyl ether, 1,6-diglycidylcyclohexane, N,N-diglycidyl-4-glycidyloxyaniline, sorbitol polyglycidyl ether, and glycerol polyglycidyl ether; aldehyde type hardening agents such as formaldehyde and glyoxal; active halogen type hardening agents such as 2,4-dichloro-6-hydroxy-1,3,5-triazine; active vinyl type hardening agents such as 1,3,5-trisacryloyl-hexahydro-s-triazine, and bis-vinylsulfonyl ether; isocyanate type hardening agents such as tolylenediisocyanate, and diphenylmethanediisocyanate; boric acid; borates; borax; and alum.

Further, hydrophilic polymer and various additives may be incorporated into the dispersion medium in advance, or be incorporated into the dispersion solution after the inorganic micro-particles are dispersed. For example, adequately employed are various nonionic or cationic surface active agents, anti-foaming agents, nonionic hydrophilic polymers such as polyvinyl alcohol, polyvinylpyrrolidone, polyethylene oxide, polyacrylamide, various saccharides, gelatin and pullulan; nonionic or cationic latex dispersion solution, water-miscible organic solvents such as ethyl acetate, methanol, ethanol, I-propanol, propanol, and acetone; inorganic salts; and pH adjusting agents, as appropriate.

The recording material of this invention is prepared by applying the coating composition containing these constituent materials onto the foregoing substrate.

The average particle diameter of the pulverized micro-particle silica is preferably 100-350 nm. In the cases when it is 100 nm or more, ink absorbability is enhanced, and when 350 nm or less, it enables obtaining good glossiness. Further, in this invention, it is preferable that the average particle diameter of the pulverized micro-particle silica (being y nm) and particle numbers having sizes of 10 μm or more in 1 g of micro-particle silica (being x particles), satisfy Formula (A).
150<y+17·In(x)<500 Formula (A)

In cases when the value of y+17·In(x) described in Formula (A) above exceeds 150, good ink absorbability results, and further, when less than 500, good glossiness results. Here, the average particle diameter of micro-particle silica is determined using, for example, Zetasizer 100HS, manufactured by Malvern Instruments Co., Ltd. A particle size of 10 μm or more in 1 g of micro-particle silica is determined by measurement using for example, Hiac/Royco Model 8000A Particle Counter, manufactured by Pacific Scientific Co., Ltd. Measurement of the particle sizes of 10 μm or more in 1 g of micro-particle silica is conducted by the steps of: preparing 0.25 weight % solution of micro-particle silica, and diluting the micro-particle silica dispersed solution; measuring particle quantity of 10 μm or more in 10 ml of the 0.25 weight % solution using the above apparatus; converting the particle quantity at a size of 10 μm or more in 1 g of micro-particle silica. The particle sizes range from 2-100 μm.

The ink absorbing layer of this invention may incorporate other inorganic micro-particles together with the above-described inorganic micro-particles. Examples of the inorganic micro-particles include white pigments such as light precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic amorphous silica, colloidal silica, alumina, colloidal alumina, pseudo boehmite, aluminum hydroxide, lithopone, zeolite, and magnesium hydroxide. The inorganic micro-particles may be employed as primary particles or may be in the state of secondary aggregated particles.

The preferably employed hydrophilic polymer in the ink absorbing layer of this invention is polyvinyl alcohol (being PVA). Examples of polyvinyl alcohols employed in this invention include, other than the usual polyvinyl alcohol obtained by hydrolysis of polyvinyl acetate, modified polyvinyl alcohols such as polyvinyl alcohol the terminal of which is cationic modified, or anionic modified polyvinyl alcohol having an anionic group. The average polymerization degree of polyvinyl alcohol obtained by hydrolysis of vinyl acetate is preferably more than 300, but is specifically preferable in the range of 1,000-5,000. The saponification degree is preferably 70-100%, but is specifically preferably 80-99.5%. In cases when the ink absorbing layer is a porous type, the weight ratio of the hydrophilic polymer to the foregoing inorganic or organic micro-particles is normally 1:10-1:3, but is specifically preferably 1:8 -1:5.

In cases when the ink absorbing layer of this invention incorporates polyvinyl alcohol as a hydrophilic polymer, addition of a hardening agent is preferred, in order to improve film formability of the layer to enhance water resistance and strength of the layer. As a hardening agent, generally preferred is a compound which has a group capable of reacting with the foregoing hydrophilic polymers, or accelerates reaction of different groups contained in the hydrophilic polymer. The hardening agent is appropriately selected based on the kinds of hydrophilic polymer. Specific examples of these hardening agents include the foregoing compounds. In cases when polyvinyl alcohol is employed as a hydrophilic polymer, it is preferable to employ a hardening agent selected from boric acid, borates and epoxy type hardening agents. The added amount of the foregoing hardening agents varies based on the kind of hydrophilic polymer, the kind of the hardening agents, the kind of micro-particle silica, and the ratio of micro-particle silica to the hydrophilic polymer, however, it is generally 5-500 mg per g the hydrophilic polymer, but preferably 10-300 mg. Further, plural kinds of hardening agents may be employed in appropriate combinations.

To the recording material of this invention, used may be various additives other than the ones above. For example, incorporated may be various well known additives, such as ultraviolet ray absorbing agents described in JP-A Nos. 57-74193, 57-87988 and 62-261476; anti-fading agents described in JP-A Nos. 57-74192, 57-87989, 60-72785, 61-146591, 1-95091, and 3-13376; various anionic, cationic or nonionic surface active agents; fluorescent brightening agents described in JP-A Nos. 59-42993, 59-52689, 62-280069, 61-242871, and 4-219266; anti-foaming agents; lubricant agents such as diethylene glycol; antiseptic agents; viscosity increasing agents; and antistatic agents.

Glossiness of the ink absorbing layer surface of the recording material of this invention is typically 40-80% based on 75° specular reflection defined in JIS Z 8741 (please refer to ISO 2813:1994, 7668:1986). As the glossiness decreases, definition of the recorded image tends to also decrease. When glossiness is measured at 75° in this invention, it is preferred that glossiness is within the above range, but when measured at lower angles, such as 60° or 45°, glossiness is typically a lower value.

The recording material of this invention is prepared by applying the coating composition forming the ink absorbing layer onto the foregoing substrate. It is preferred that the foregoing inorganic micro-particles, preferably employed in the ink absorbing layer, are adequately dispersed in the dispersion medium before dispersion in the coating composition.

Regarding the coating of the ink absorbing layer, it is preferable that the substrate is subjected to a corona discharge treatment or is provided with a subbing layer, to enhance adhesion strength between the substrate surface and the coated layer. The subbing layer employs a hydrophilic polymer such as gelatin or polyvinyl alcohol, in combination with a hardening agent, if appropriate. The preferable thickness of the subbing layer is in the range of 0.01-1 μm.

In cases when use of the recording material of this invention is for only single surface recording, various kinds of backing layers may be provided on the opposite side of the ink absorbing layer, primarily to reduce curling, sticking or ink transfer when stacked immediately after printing. The configuration of the backing layer may vary with the kind and thickness of the substrate, as well as composition and thickness of the surface side layer, but generally a hydrophilic binder or a hydrophobic binder is employed. The thickness of the backing layer is usually in the range of 0.1-10 μm. Further, the surface of the backing layer may be roughened to minimize sticking to previous recording material, to improve writability, and further, to improve transportability with the ink-jet recording apparatus. For this purpose, preferably employed are organic or inorganic micro-particles exhibiting an average particle diameter of 0.5-20 μm. The backing layer may be applied first, or after the ink absorbing layer is applied onto the opposite side.

Preferably employed coating methods include a roller coating method, a rod bar coating method, an air knife coating method, a spray coating method, a curtain coating method, and an extrusion coating method-employing a hopper, described in U.S. Pat. No. 2,681,294. In cases when polyolefin coated paper is employed for the substrate, drying is preferably conducted in the range of about 0-80° C. When it exceeds 80° C., polyolefin resin is softened resulting in conveying problems, or mottled glossiness of the recording layer surface. The more preferable drying range is 0-60° C.

After drying, over-coated may be a solution containing various additives known in the art, such as the foregoing surface active agents, UV absorbing agents, anti-fading agents, hardening agents, mordants, anti-foaming agents, fluorescent brightening agents, lubricant agents, antiseptic agents, and viscosity increasing agents.

As examples of surface active agents, listed are anionic surface active agents, cationic surface active agents, ampholytic surface active agents, and nonionic surface active agents, of which, the anionic surface active agent or cationic surface active agent are preferably employed singly, or in combination.

To the over-coat coating composition, inorganic particles and/or organic particles may also be incorporated. As inorganic particles, listed are a white pigment, such as light precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic amorphous silica, colloidal silica, alumina, colloidal alumina, pseudo boehmite, aluminum hydroxide, lithopone, zeolite, and magnesium hydroxide. Further, as organic particles, listed are acryl resin, urea resin, melamine resin, phenol resin and styrene resin.

The method to provide the overcoat layer on the ink absorbing layer is not specifically limited, and coating apparatus or printers, conventionally known methods in the art, such as a bar coater, an air knife coater, a blade coater, or a curtain coater may be employed. Further, the coating amount of the overcoat layer is not necessarily large as long as it satisfies the desired properties, but preferably is in the range of 0.1-10 g/m².

Next, the ink-jet recording method of the present invention will be described.

An ink-jet recording method ejecting a water based ink onto the foregoing ink-jet recording material of this invention is not specifically limited, and a text or an image may be produced using a piezo type or a thermal type ink-jet printer. The specific details of recording methods are described in, for example, Ink-jet Kiroku Gijutu no Doko (Trend of Ink-jet Recording Technology), Nippon Kagaku Joho Sha (Japan Science Information Co., Ltd.).

Employable water based inks are not limited, except that each of the inks should contain the dye represented by Formula (1), C. I. Direct Blue 199 dye and C. I. Direct Yellow 86 dye, but may also contain other colorants such as oil dyes, dispersed dyes, direct dyes, acid dyes, water soluble dyes and basic dyes. The above dyes are described in Dyeing Notes, second edition, published by Shikisensha Co., Ltd. Further, preferably employed water based inks are to adequately incorporate various additives, known in the art, such as a lubricant agent, e.g. polyhydric alcohol, a dispersing agent, a silicone type anti-foaming agent, a chloromethylphenol type fungicide, and/or a chelating e.g. EDTA (ethylenediamine tetraacetate), and further an auxiliary agent, e.g. an oxygen absorption agent of a sulfite.

Ink-jet heads employable in the ink-jet recording method of this invention may be an on-demand type or a continuous type. Further, as specific examples of employable ink ejecting methods, listed are an electro-mechanical conversion method (such as a single cavity type, a double cavity type, a bender type, a piston type, a share mode type and a shared wall type), an electro-thermal conversion method (being a thermal ink-jet type, a Bubble Jet® type), an electrostatic suction method (being an electro-field control type, and a slit jet type), and an electric discharge method (being a spark jet type), as well as other appropriate ejecting methods.

### EXAMPLE

The present invention will now be exemplified referring to examples, but this invention is not limited to them.

Mordant and Rf Value of Flow Rate

In Table 1, the measured results of the Rf values of the flow rate of the dye represented by Formula (1), C. I. Direct Blue 199 dye and C. I. Direct Yellow 86 dye, are shown, using thin layer chromatography, immersion coating employing various mordants. The Rf values of the flow rate were measured via the following method. Firstly, 1 weight % aqueous solution of the mordant was prepared. Then a commercially available TLC aluminum plate of Silica Gel 60F254 (produced by Merck & Co., Inc., size: 20×20 cm, thickness of a silica gel layer: 200 μm) was cut into 1×10 cm pieces, after which the pieces were thoroughly soaked in the aqueous solution of the mordant, preparing a thin layer chromatograph, immersion coated with the mordant. Next, onto this thin layer chromatograph plate, about 0.1 μl of 1 weight % aqueous solution of the dye [being the dye represented by foregoing Formula (1), C. I. Direct Blue 199 or C. I. Direct Yellow 86] was dripped. After drying, one end of the plate was immersed into a developing solvent containing methanol and water, at a volume ratio of 1:1, and the vessel was tightly sealed for development. The Rf flow rate value was then determined, which was the distance ratio of the dye and the developing solvent, when the developing solution migrated to a specific height. In cases when the dye migrated over a range, the largest value was employed for the Rf value.

TABLE 1

| | Rf value of flow rate | | |
|---|---|---|---|
| | Dye | | C.I. |
| | represented | C.I. | Direct |
| Kind or Mordant | by Formula | Direct Blue | Yellow 86 |
| (at a ratio) | (1) | 199 dye | dye |
| P-1,P-2(1:1) | 0.35 | 0.20 | 0.30 |
| P-1,P-2(2:1) | 0.30 | 0.15 | 0.40 |
| P-1,Al₂(OH)₅Cl(1:1) | 0.25 | 0.20 | 0.35 |
| P-1,P-3(1:1) | 0.35 | 0.25 | 0.45 |
| P-1 | 0.38 | 0.28 | 0.48 |
| P-2 | 0.45 | 0.35 | 0.55 |
| Al₂(OH)₅Cl | 0.50 | 0.40 | 0.55 |
| P-3 | 0.55 | 0.45 | 0.60 |

| | |
|---|---|
| P-1 | 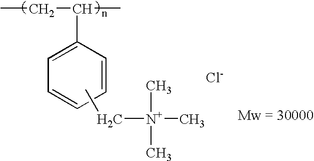 |
| P-2 | 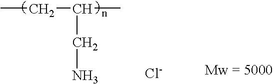 |
| P-3 | 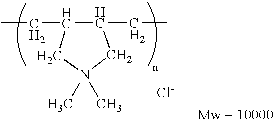 |

In Table 1, the Rf flow rate values described in claim 1 were satisfied, except when the mordants were P-2, AL₂(OH)₅Cl or P-3.

Preparation of Substrate

Onto the rear surface of the base paper for photography exhibiting a 6.5% water content and 170 g/m² basic weight, low density polyethylene at a density of 0.92 was coated at a thickness of 30 μm using a melt extrusion coating method. Subsequently, to prepare a substrate both sides of which were covered by polyethylene, onto the front surface, low density of 0.92 polyethylene containing 5.5% anatase type titanium oxide, was coated at a thickness of 35 μm, using a melt extrusion method. The front surface was subjected to corona discharge, after which a gelatin subbing layer was applied at a thickness of 0.3 g/m², and the rear surface was also subjected to corona discharge, onto which a latex layer was applied at a thickness of 0.2 g/m².

Preparation of Titanium Oxide Dispersion Solution 1

To 90 l of an aqueous solution containing 150 g of sodium tripolyphosphate at a pH of 7.5, 500 g of polyvinyl alcohol (such as PVA235, produced Kuraray Co., Ltd.), 150 g of cationic polymer (being P-1), and 10 g of an anti-foaming agent (such as SN381, produced by Sun Nopco Ltd., added was 20 kg of titanium oxide (being W-10, produced by Ishihara Sangyo Kaisha Ltd.), having an average particle diameter of about 0.25 μm, after which the solution was dispersed using a high pressure homogenizer (manufactured by Sanwa Industries Co., Ltd.), after which the total volume was brought to 100 l, to prepare uniform Titanium Oxide Dispersion Solution 1.

Preparation of Fluorescent Brightening Agent Dispersion Solution 1

400 g of oil soluble fluorescent brightening agent Uvitex-OB, produced by Ciba Geigy AG, was heated and dissolved in 9,000 g of di-isodecylphthalate and 12 l of ethyl acetate, after which the resulting solution was added and mixed into 65 l of an aqueous solution containing 3,500 g of acid process gelatin, 0.8 kg of cationic polymer (being P-1), and 6 1 of 50% saponin aqueous solution, followed by the solution being dispersed into the emulsion using a high pressure homogenizer, manufactured by Sanwa Industries Co., Ltd. After ethyl acetate was removed under reduced pressure, the total volume was brought to 100 l, to prepare Fluorescent Brightening Agent Dispersion Solution 1.

Preparation of Silica Dispersion Solution 1

| | |
|---|---|
| Water | 80 l |
| Boric acid | 0.27 kg |
| Borax | 0.23 kg |
| 5% Nitric acid | 0.4 l |
| Ethanol | 1.8 l |
| Cationic polymer (P-1) (being a 25 weight % | 3 l |
| aqueous solution) | |
| Cationic polymer (P-2) (being a 25 weight % | 3 l |
| aqueous solution) | |

The materials above were mixed and dissolved to produce a water base medium (hereinafter, referred to as Solution A). As silica, prepared was 32 kg of sedimentation silica (sold under the trade name of T-32, having an average secondary particle diameter of 1.5 μm, produced by Tokuyama Corp., hereinafter, referred to as T-32), and dispersed as described below, to obtain Silica Dispersion Solution 1. Into Disperser 1 of Flow Jet Mixer Type 300 (being a pin mixer type, manufactured by Funken Powtechs, Inc., and hereinafter, referred to as FJM), supplied were Solution A at 56 kg/min. and T-32 at 0.44 kg/min. After which, the solution was fed to Disperser-2 of Fine Flow Mill FM-25 (being a continuous type, high speed stirring type disperser, manufactured by Pacific Machinery & Engineering Co., Ltd., hereinafter, referred to as FM). Then, to Disperser 3 of LMK-4. (being a continuous type, wet media type grinding machine, manufactured by Ashizawa Finetech Ltd., and hereinafter, referred to as LMK), the dispersion solution fed from Disperser 2 was supplied using a Mono pump at 2.0 kg/min. The peripheral velocity of FJM was 25 m/sec. for duration of 20 sec. The peripheral velocity of FM was 25 m/sec. for a duration of 0.15 sec. LMK employed 0.5 mm zirconia beads, for a duration of 5 min. and peripheral velocity of the rotor was 11 m/sec. After that, the dispersion solution fed from LMK was filtered, using a Profile filter, manufactured by Nippon Poll Ltd. The average particle diameter and the particle quantity of 10 μm and more, were determined, and the value of foregoing Formula (A) was determined to be 380, and the average particle diameter was 200 nm.

Preparation of Silica Dispersion Solution 2

| | |
|---|---|
| Cationic polymer (P-1) (being a 25 weight % | 4 l |
| aqueous solution) | |
| Cationic polymer (P-2) (being a 25 weight % | 2 l |
| aqueous solution) | |

Preparation of Silica Dispersion Solution 3

Silica Dispersion Solution 3 was prepared in the same manner as Silica Dispersion Solution 1, except that silica was replaced with gel method silica (under the trade name of AZ-204, at an average secondary particle diameter of 1.3 μm, produced by Nippon Silica Industrial Co., Ltd.). The value of foregoing Formula (A) was 400, at an average particle diameter of 220 nm.

Preparation of Silica Dispersion Solution 4

Silica Dispersion Solution 4 was prepared in the same manner as Silica Dispersion Solution 1, except that silica was replaced with gas phase silica (under the trade name of A-300, produced by Nippon Aerosil Co., Ltd.). The value of foregoing Formula (A) was 300, at an average particle diameter of 170 nm.

Preparation of Silica Dispersion Solution 5

| | |
|---|---|
| Cationic polymer (P-1) (being a 25 | 3 l |
| weight % aqueous solution) | |
| Al₂(OH)₅Cl (being a 25% aqueous solution) | 3 l |

Silica Dispersion Solution 5 was prepared in the same manner as Silica Dispersion Solution 1, except that cationic polymers P-1 and P-2 were replaced with the above. The value of foregoing Formula (A) was 400, at an average particle diameter of 210 nm.

Preparation of Silica Dispersion Solution 6

| | |
|---|---|
| Cationic polymer (P-1) (being a 25 | 3 l |
| weight % aqueous solution) | |
| Cationic polymer (P-3) (being a 25 | 3 l |
| weight % aqueous solution) | |

Silica Dispersion Solution 6 was prepared in the same manner as Silica Dispersion Solution 1, except that cationic polymers P-1 and P-2 were changed to the above. The value of foregoing Formula (A) was 370, at an average particle diameter of 200 nm.

Preparation of Silica Dispersion Solution 7

| | |
|---|---|
| Cationic polymer (P-1) (being a 25 | 6 l |
| weight % aqueous solution) | |

Silica Dispersion Solution 7 was prepared in the same manner as Silica Dispersion Solution 1, except that cationic polymers P-1 and P-2 were changed to the above. The value of foregoing Formula (A) was 370, at an average particle diameter of 210 nm.

Preparation of Silica Dispersion Solution 8

| | |
|---|---|
| Cationic polymer (P-2) (being a 25 | 6 l |
| weight % aqueous solution) | |

Silica Dispersion Solution 8 was prepared in the same manner as Silica Dispersion Solution 1, except that cationic polymers P-1 and P-2 were changed to the above. The value of foregoing Formula (A) was 400, at an average particle diameter of 220 nm.

Preparation of Silica Dispersion Solution 9

Al₂(OH)₅Cl (being a 25 weight % aqueous solution) 6 l.

Silica Dispersion Solution 9 was prepared in the same manner as Silica Dispersion Solution 1, except that cationic polymers P-1 and P-2 were changed to the above. The value of foregoing Formula (A) was 410, at an average particle diameter of 200 nm.

Preparation of Silica Dispersion Solution 10

| | |
|---|---|
| Cationic polymer (P-3) (being a 25 | 6 l |
| weight % aqueous solution) | |

Silica Dispersion Solution 10 was prepared in the same manner as Silica Dispersion Solution 1, except that cationic polymers P-1 and P-2 were changed to the above. The value of foregoing Formula (A) was 420, at an average particle diameter of 220 nm.

The average particle diameter was the value obtained using Zetasizer 1000Hs, manufactured by Malvern Instruments Co., Ltd. The value of Formula (A) was determined employing y+17·In(x). Here, the average particle diameter of pulverized silica was y (nm), and the particle quantity of 10 μm and larger in 1 g of micro-particle silica was x (particles). The particle quantity of 10 μm and larger were the measured value using Hiac/Royco Model 8000A Particle Counter, manufactured by Pacific Scientific Co., Ltd. The measurement of particle quantity of more than 10 μm was conducted as follows: diluting a micro-particle silica dispersion solution to become 0.25% by weight concentration of micro-particle silica; determining the quantity of particles of 10 μm or larger in 10 ml of the 0.25 weight % solution using the above apparatus; converting to the quantity of particles at 10 μm or larger in 1 g of micro-particle silica. The measured value range was 2-100 μm.

Preparation of Ink-jet Recording Material 1

The coating compositions for the first layer, the second layer and the third layer were prepared employing the following procedure.

Coating Composition for First Layer

To 560 ml of the dispersion solution prepared from Silica Dispersion Solution 1 adjusted to be 10% of silica weight content in the dispersion solution, the following additives were sequentially added, while stirring at 40° C.

| | | |
|---|---|---|
| Polyvinyl alcohol (being PVA203, produced | 0.6 | ml |
| by Kuraray Co., Ltd.) (being a 10% aqueous | | |
| solution) | | |
| Polyvinyl alcohol (being PVA235, produced | 150 | ml |
| by Kuraray Co., Ltd.) (being a 5% aqueous | | |
| solution) | | |
| Polyvinyl alcohol (being PVA245, produced | 100 | ml |
| by Kuraray Co., Ltd.) (being a 5% aqueous | | |
| solution) | | |
| Fluorescent Brightening Agent dispersion | 32 | ml |
| Solution 1 | | |
| Titanium Oxide Dispersion Solution 1 | 30 | ml |
| Latex Emulsion (being AE-803, produced by | 21 | ml |
| Showa Highpolymer Co., Ltd.) | | |
| Water | to make 1,000 | ml |

Coating Composition for Second Layer

To 630 ml of the dispersion solution prepared from Silica Dispersion Solution 1 adjusted to be 10% of silica weight content in the dispersion solution, the following additives were sequentially added, while stirring at 40° C.

| | | |
|---|---|---|
| Polyvinyl alcohol (being PVA203, produced | 0.6 | ml |
| by Kuraray Co., Ltd.) (being a 10% aqueous | | |
| solution) | | |
| Polyvinyl alcohol (being PVA235, produced | 150 | ml |
| by Kuraray Co., Ltd.) (being a 5% aqueous | | |
| solution) | | |
| Polyvinyl alcohol (PVA245, being a 5% | 100 | ml |
| aqueous solution produced by Kuraray | | |
| Co., Ltd.) | | |
| Fluorescent Brightening Agent Dispersion | 50 | ml |
| Solution 1 | | |
| Water | to make 1,000 | ml |

Coating Composition for the Third Layer

| | | |
|---|---|---|
| Polyvinyl alcohol (being PVA203, produced | 0.6 | ml |
| by Kuraray Co., Ltd.) (being a 10% aqueous | | |
| solution) | | |
| Polyvinyl alcohol (being PVA235, produced | 150 | ml |
| by Kuraray Co., Ltd.) (being a 5% aqueous | | |
| solution) | | |
| Polyvinyl alcohol (PVA245, being a 5% | 100 | ml |
| aqueous Solution, produced by | | |
| Kuraray Co., Ltd.) | | |
| Silicone dispersion solution (being | 3.5 | ml |
| a BY-22-839, produced by Doe Corning Toray | | |
| Silicone Co., Ltd.) | | |
| Saponin (being a 50% aqueous solution) | 4 | ml |
| Fluorochemical nonionic surface active agent | 2 | ml |
| (being a 5% aqueous solution) | | |
| Water | to make 1,000 | ml |

Coating

The obtained coating compositions prepared above were simultaneously applied to the foregoing substrate, covering both sides with polyethylene in the order of the first layer at a thickness of 40 μm, the second layer at a thickness of 110 μm and the third layer at a thickness of 30 μm. Each of the values in the parentheses was the wet thickness. Coating was conducted as a simultaneous coating at 40° C. of each coating composition using a three layer curtain coater, after which the coated substrate was cooled with 8° C air for 20 seconds in a cooling zone, and after that, it was dried with air in the following orders: 20-30° C. for 60 seconds, 45° C. for 60 seconds and at 50° C. for 60 seconds. The temperature of-the coated layers was 8-25° C. in the region of a constant rate of drying and the temperature of the coated layers rose gradually in the region of a falling rate of drying. After which, it was humidity conditioned at 40-60% RM, to obtain Ink-jet Recording Material 1.

Preparation of Ink-jet Recording Materials 2-11

Ink-jet Recording Materials 2-10 were prepared in the same manner as Ink-jet Recording Material 1, except that Silica Dispersion Solution 1 was respectively replaced with Silica Dispersion Solutions 2-10. Next, Ink-jet Recording Material 11 was prepared in the same manner as Ink-jet Recording Material 1, except that Silica Dispersion Solution 1 in the first and the second layers was replaced by Silica Dispersion Solution 8.

Regarding the obtained ink-jet recording materials, the kinds of silica, kinds of mordant, and 75° specular glossiness are shown in Table 2. The glossiness was measured using VGS-1001DP Type Glossmeter, manufactured by Nippon Denshoku Industries Co., Ltd. employing an incidence angle of 75° and a light receiving angle of 75°, based on JIS Z 8741.

TABLE 2

| Receiving | | | Glossiness | |
|---|---|---|---|---|
| Material | Silica | Mordant (Ratio) | (%) | Remarks |
| 1 | Sedimentation | P-1, P-2(1:1) | 70 | Inv. |
| | method | | | |
| 2 | Sedimentation | P-1, P-2(2:1) | 68 | Inv. |
| | method | | | |
| 3 | Gel method | P-1, P-2(1:1) | 67 | Inv. |
| 4 | Gas phase | P-1, P-2(1:1) | 72 | Inv. |
| | method | | | |
| 5 | Sedimentation | P-1, | 69 | Inv. |
| | method | Al₂(OH)₅Cl(1:1) | | |
| 6 | Sedimentation | P-1, P-3(1:1) | 70 | Inv. |
| | method | | | |
| 7 | Sedimentation | P-1 | 69 | Inv. |
| | method | | | |
| 8 | Sedimentation | P-2 | 68 | Comp. |
| | method | | | |
| 9 | Sedimentation | Al₂(OH)₅Cl | 70 | Comp. |
| | method | | | |
| 10 | Sedimentation | P-3 | 68 | Comp. |
| | method | | | |
| 11 | Sedimentation | Upper layer P-1, P-2 | 70 | Inv. |
| | method | (1:1), lower layer | | |
| | | P-2 | | |

Note:
Inv.: this invention
Comp.: comparative example

Evaluation of Ink-Jet Image
Evaluation of Ink Absorbability

Using Color Ink-jet Printer PM800C, manufactured by Seiko Epson Corp., solid yellow ink images containing C. I. Direct Yellow 86 dye, solid magenta ink images containing the dye represented by Formula (1), and solid cyan ink images containing C. I. Direct Blue 199 dye, were printed onto Recording Materials 1-11, as prepared above, after which clean copying paper was lightly laid on the printed images (being about 10 seconds later), and ink absorbability to the recording materials and ink transfer onto the copying paper were visually observed and evaluated based on the following criteria. The results are shown in Table 3.
A: Ink absorbing rate was satisfactory, and no ink transfer was observed.
B: Ink absorbing rate was high, but slight ink transfer was observed.
C: Ink absorbing rate was rather low, and ink transfer to a copy paper was observed.
D: Ink absorbing rate was low, and ink spreading was observed.
   Evaluation of Resolution

Using Color Ink-jet Printer PM800C, manufactured by Seiko Epson Corp., 100 μm wide lines of: each yellow ink containing C. I. Direct Yellow 86 dye, magenta ink containing the dye represented by Formula (1), and cyan ink containing C. I. Direct Blue 199 dye, were printed onto foregoing Recording Materials 1-11, prepared as above, after which evaluation was visually conducted at a magnification factor of 50 using a microscope. The results are shown in Table 3.
A: Dot shape was very sharp.
B: Dot shape was quite sharp.
C: Dot shape was blurred in parts, but no problem in a commercial viability.
D: Dot shape was blurred.
   Evaluation of Image Quality

Using Color Ink-jet Printer PM800C, manufactured by Seiko Epson Corp., a black text image were printed on a solid yellow image containing C. I. Direct Yellow 86 dye, on a solid magenta image containing the dye represented by Formula (1), and on a solid cyan image containing C. I. Direct Blue 199 dye, being printed onto Recording Materials 1-11, prepared as above, after which evaluation was visually conducted based on the following criteria. The results of which are shown in Table 3.
A: No bleeding was observed on the text.
B: Slight bleeding was observed on the text, but still commercially viable.
C: Bleeding was observed on the text, and at a commercial viability.
D: The bleeding level was completely unacceptable.
   Evaluation of Coloration

Using Color Ink-jet Printer PM800C, manufactured by Seiko Epson Corp., a solid black image was printed on foregoing Recording Materials 1-11, prepared as above, the reflected density of each black image was measured using an X-Rite 938 Densitometer, manufactured by X-Rite, Inc. The results of which are shown in Table 3.

Resolution and image quality can represent the dye fixing capability of the mordant, therefore, it can be claimed that water resistance and humidity resistance are evaluated by those features.

TABLE 3

| Recording | Ink | | Image | | |
|---|---|---|---|---|---|
| Material | absorbability | Resolution | quality | Coloration | Remarks |
| 1 | A | B | A | 2.3 | Inv. |
| 2 | B | A | A | 2.4 | Inv. |
| 3 | A | B | A | 2.3 | Inv. |
| 4 | B | A | A | 2.4 | Inv. |
| 5 | A | A | A | 2.3 | Inv. |
| 6 | A | A | B | 2.4 | Inv. |
| 7 | B | B | A | 2.3 | Inv. |
| 8 | B | C | C | 2.0 | Comp. |
| 9 | B | C | C | 1.9 | Comp. |
| 10 | B | C | C | 1.8 | Comp. |
| 11 | A | B | A | 2.3 | Inv. |

As is apparent from Table 3, it was proven that images printed onto the recording materials of the present invention using the recording method of this invention, exhibited superiority in ink absorbability and excellent overall effects in resolution, image quality and coloration.

1. An ink-jet recording material comprising a substrate having thereon an ink absorbing layer containing a mordant which exhibits the following properties:
when a thin layer chromatography is prepared by immersion coating using 1 weight % aqueous solution of the mordant, the thin layer chromatography results in;
a) an Rf flow rate value being equal to or less than 0.4, when a dye represented by following Formula (1) is developed using a developing solvent containing ethanol and water at a volume ratio of 1:1;
b) the Rf value being equal to or less than 0.3, when C. I. Direct Blue 199 dye is developed using a developing solvent containing ethanol and water at a volume ratio of 1:1; and
c) the Rf value being equal to or less than 0.5, when C. I. Direct Yellow 86 dye is developed using a developing solvent containing ethanol and water at a volume ratio of 1:1.

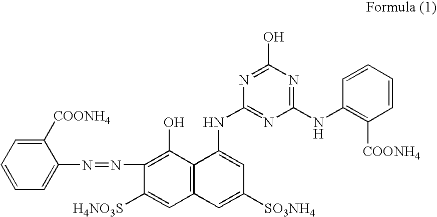

2. The ink-jet recording material of claim 1, wherein the ink absorbing layer comprising pulverized silica micro-particles which are produced by a sedimentation method or a gel method.

3. The ink-jet recording material of claim 2, wherein the mordant comprises a cationic polymer containing polystyrene having a quaternary ammonium salt group.

4. The ink-jet recording material of claim 3, wherein the mordant further comprises a cationic polymer having a polyacrylamine salt group.

5. The ink-jet recording material of claim 3, wherein the mordant further comprises a cationic polymer having a polydiallyldimethyl ammonium salt group.

6. The ink-jet recording material of claim 3, wherein the mordant further comprises a basic aluminum chloride.

7. An ink-jet recording method comprising the step of ejecting droplets of the following set of inks from an ink-jet head onto the ink-jet recording material of claim 2, the set of inks containing:
a) a water based ink comprising the dye represented by Formula (1), 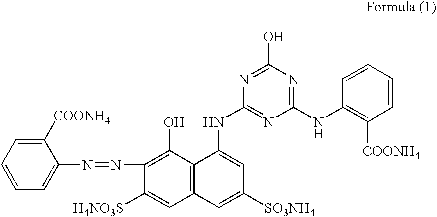
b) a water based ink comprising C. I. Direct Blue 199 dye, and
c) a water based ink comprising C. I. Direct Yellow 86 dye.
